(19) United States
(12) Patent Application Publication
(10) Pub. No.: US 2005/0103217 A1
(43) Pub. Date: May 19, 2005

(54) Method for automatically washing the inking circuit in rotary printing presses and plant for implementing said method

(76) Inventor: Marco Biasini, Piacenza (IT)

Correspondence Address: STITES & HARBISON PLLC, 1199 NORTH FAIRFAX STREET, SUITE 900, ALEXANDRIA, VA, 22314, US

(21) Appl. No.: 10/505,363

(22) PCT Filed: Apr. 3, 2003
(86) PCT No.: PCT/EP03/03476

(30) Foreign Application Priority Data
Apr. 24, 2002 (IT) GE2002A000033

(51) Int. Cl. B41F 35/00

(52) U.S. Cl. 101/425

(57) ABSTRACT

The invention relates to a plant for automatically washing the inking circuit in rotary printing presses, comprising a chamber (2) for inking cylinder (1); lines (4′, 4, 6, 8, 8′, 8″) which connect said chamber (2) to a tank (3) for the ink; means (5) for pumping the ink from said tank (3) via said lines (4′ 4, 6, 8′, 8″) to a said chamber (2) and from the latter to the tank (3) again; a tank (23) for the clean solvent; lines (22, 20′) provided with means able to connect said tank (23) to said line (4); a tank for the dirty solvent (12′) and lines (15, 12) provided with means able to connect said tank (12) to said line (8′). According to a main characteristic feature of said plant, the means (5) for pumping the ink consist of a peristaltic pump, the rotor of which is actuated by a motor with a reversible direction of rotation. The invention also comprises a method for automatically washing the inking in rotary printing presses using the abovementioned plant, which method is characterized by the step of intermittently introducing air into the flow of solvent circulated in the lines to be washed, which produces an intermittent acceleration of the body of solvent inside the lines, increasing the action of separation of the ink from the walls of the lines by the solvent.

The present invention relates to rotary printing presses such as, for example, flexographic printing presses or offset printing presses, and more particularly relates to a method for automatically washing the inking assembly of the printing cylinders in these presses and the parts associated with the circuit thereof, in particular, although not exclusively in presses of the abovementioned type for polychromatic printing.

The present invention relates furthermore to a plant for implementing this method.

EP-0,780,228 discloses a method and a device for cleaning the doctor device of an inking assembly of a rotary printing press. In accordance with this method, the ink is returned from the inking compartment to the ink tank again. Subsequently, solvent is pumped into the inking compartment and is then conveyed into the ink tank via the ink supply and discharge lines. Thereafter, the solvent contaminated by the ink is pumped into the dirty-solvent tank, clean solvent being then pumped in a closed circuit along the ink supply and discharge lines for a certain period of time and then discharged into the dirty-solvent tank. The plant for implementing this method requires a plurality of pumps for supplying and discharging the ink from the inking chamber, which, in addition to a constructional complication, also has the drawback that there are zones of the line which are never cleaned in a satisfactory manner.

Moreover, the solvent used in the washing operation is not recycled—even partly—for the subsequent washing cycles, therefore negatively affecting the costs of the process.

The object of the present invention, therefore, is to overcome the disadvantages of the known methods for washing the lines for supplying and discharging the ink from the inking chamber of a rotary printing press. According to a main characteristic feature of the present invention, this object is achieved by using in the ink circuit a pump, the direction of delivery of which may be reversed by means of simple reversal of the direction of rotation of the pump's rotor. This object is achieved advantageously, although not necessarily, using a peristaltic pump.

According to a further characteristic feature of the present invention, it has been found that it is possible to increase the action of the solvent in the lines to be washed, by injecting intermittently air into the flow of solvent, so as to make the body of solvent in the pipes elastically compressible, owing to the presence therein of the air cushions, so that the intermittent acceleration of the body caused by the intermittent introduction of air therein also results in a mechanical action of separation of the ink from the walls of the lines, which, added to the action of the solvent, allows particularly efficient cleaning of these lines.

According to a further characteristic feature of the present invention, the semi-dirty washing solvent is stored and used in the subsequent washing cycle.

Advantageously, the whole washing process is automated, and this process requires only very limited manual intervention for implementation thereof, which, if necessary, could also be automated.

Further objects and advantages of the automatic washing method according to the present invention will emerge more clearly during the course of the following description of a plant for implementing said method, shown schematically in the accompanying drawings, illustrating by way of a non-limiting example an embodiment of the washing plant according to the present invention, for washing the inking cylinder and the circuit, associated therewith, of a rotary printing press. In the drawings:

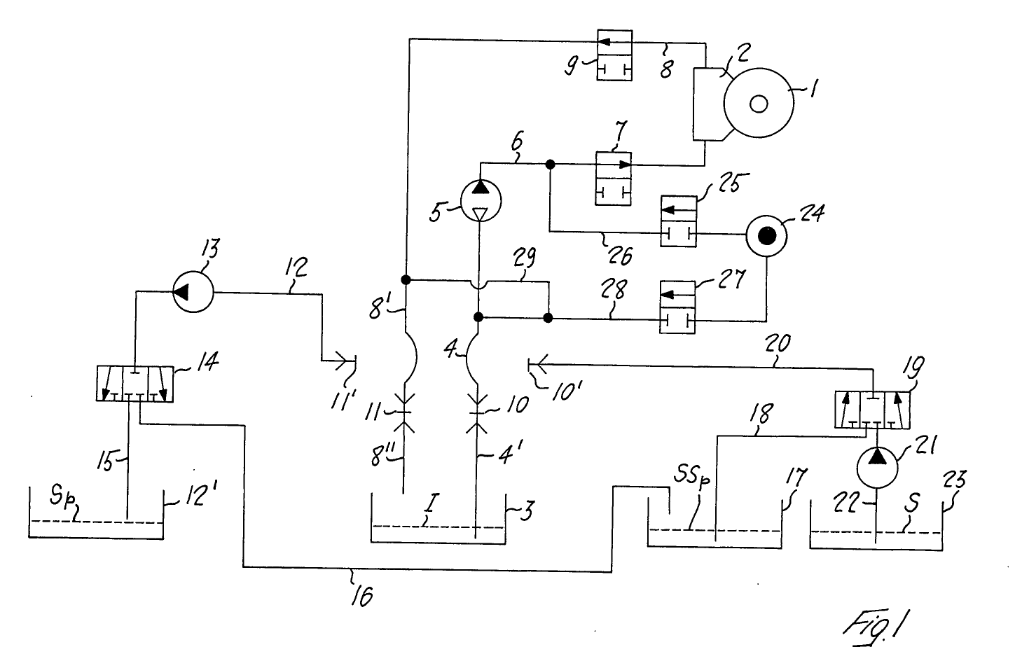

FIG. 1 illustrates schematically the inking circuit of the inking cylinder of a rotary printing press during the step for supplying the ink to the inking cylinder, with the washing circuit of the inking circuit in the inactive condition;

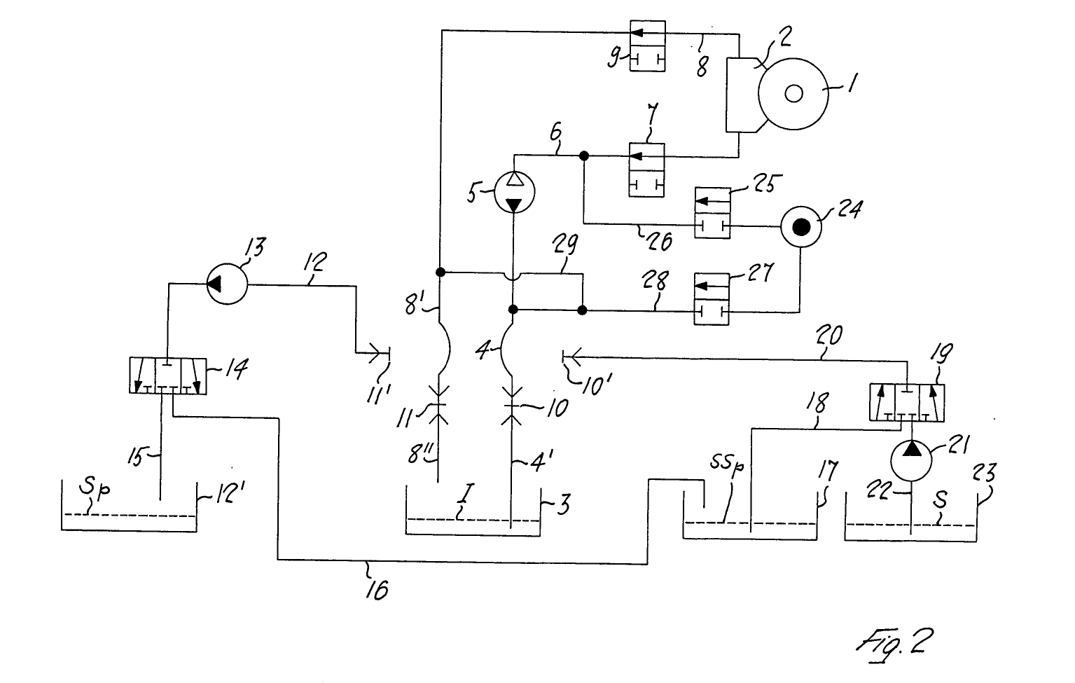

FIG. 2 is a view similar to that of FIG. 1, illustrating the step for emptying the ink from the inking lines and from the inking cylinder, with discharging of the ink into the ink tank;

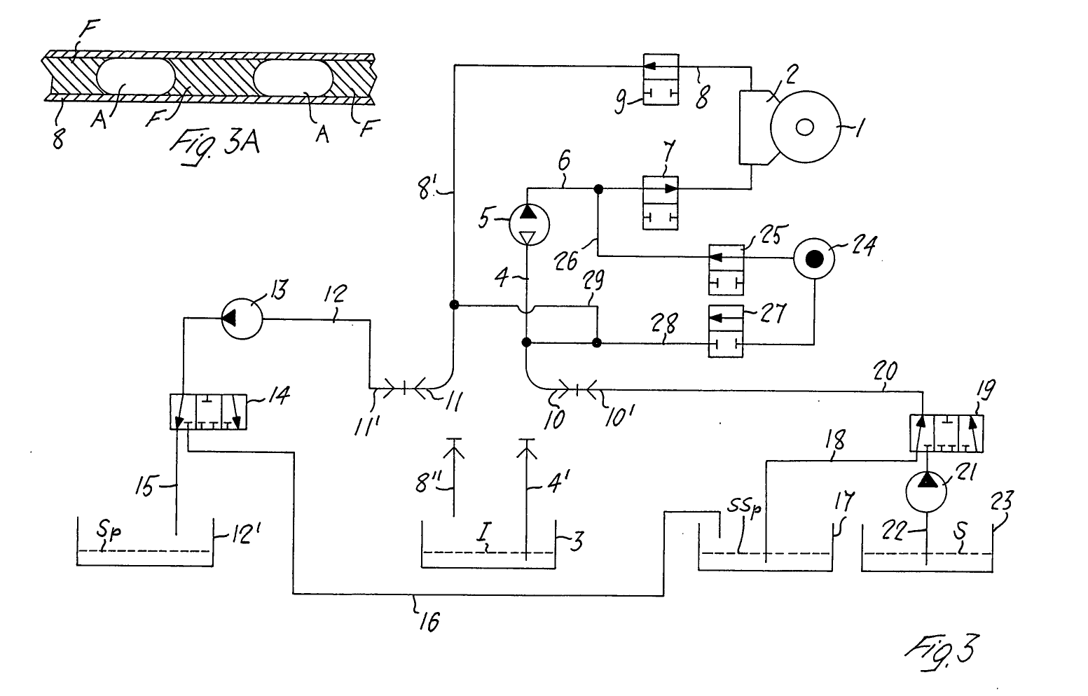

FIG. 3 illustrates the first step for washing the inking circuit using semi-dirty recycled solvent and with discharging of the dirty solvent in the tank for collecting this solvent;

FIG. 3A shows a longitudinal section through a detail of a part of a solvent conveying line containing portions of solvent separated by a series of air bubbles;

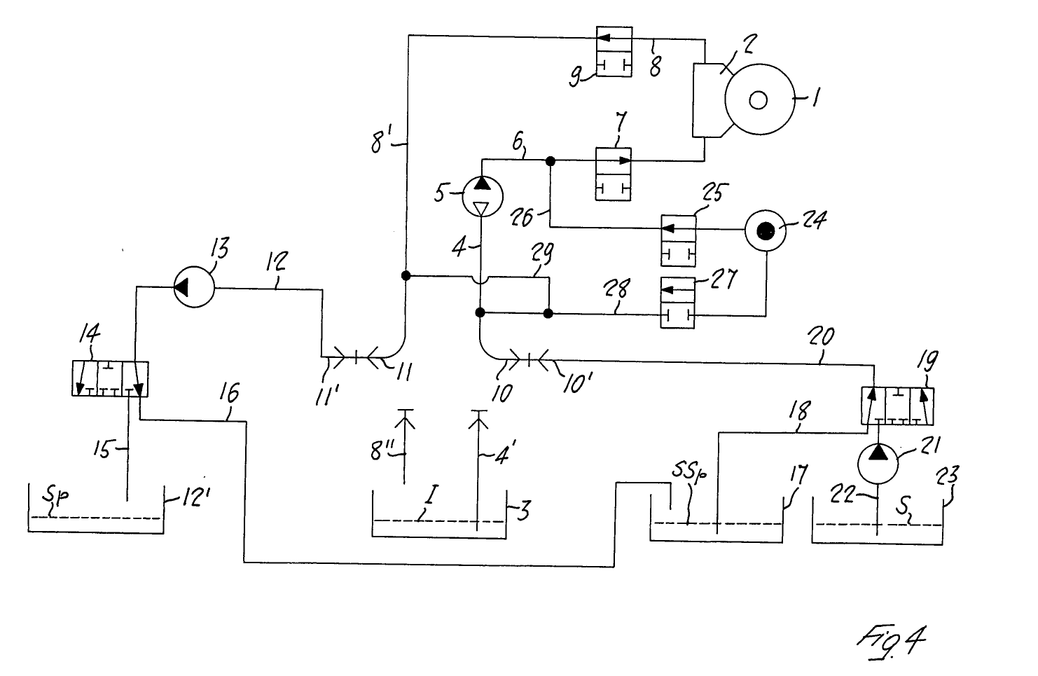

FIG. 4 illustrates the second step for washing, in a closed circuit, the inking circuit using semi-dirty recycled solvent;

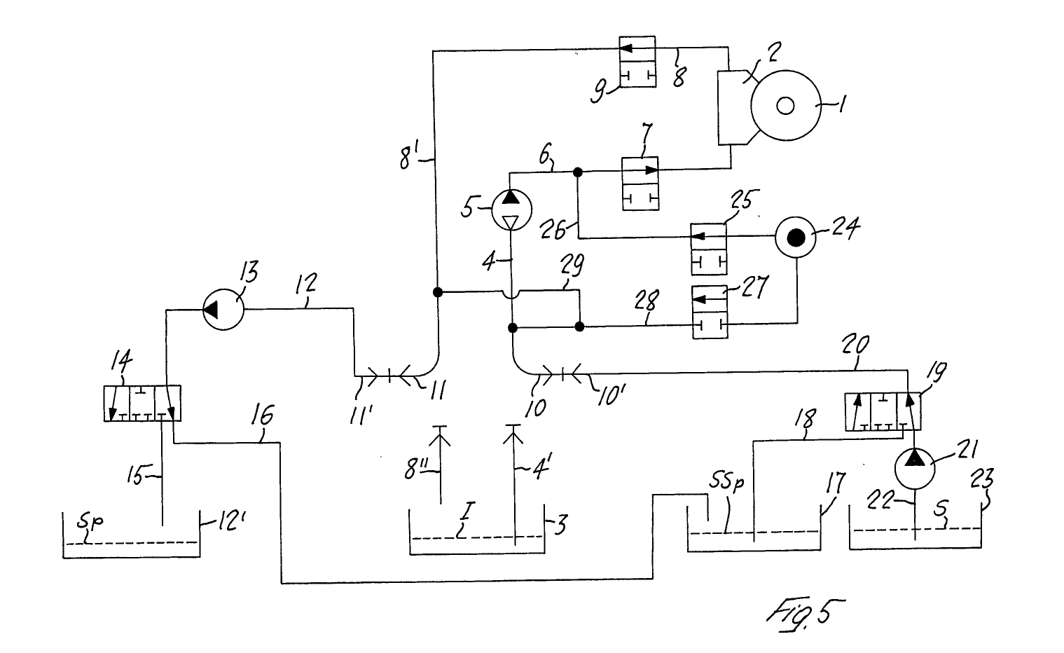

FIG. 5 illustrates the step for washing the inking circuit using clean solvent, with collection of this solvent in the semi-dirty solvent tank;

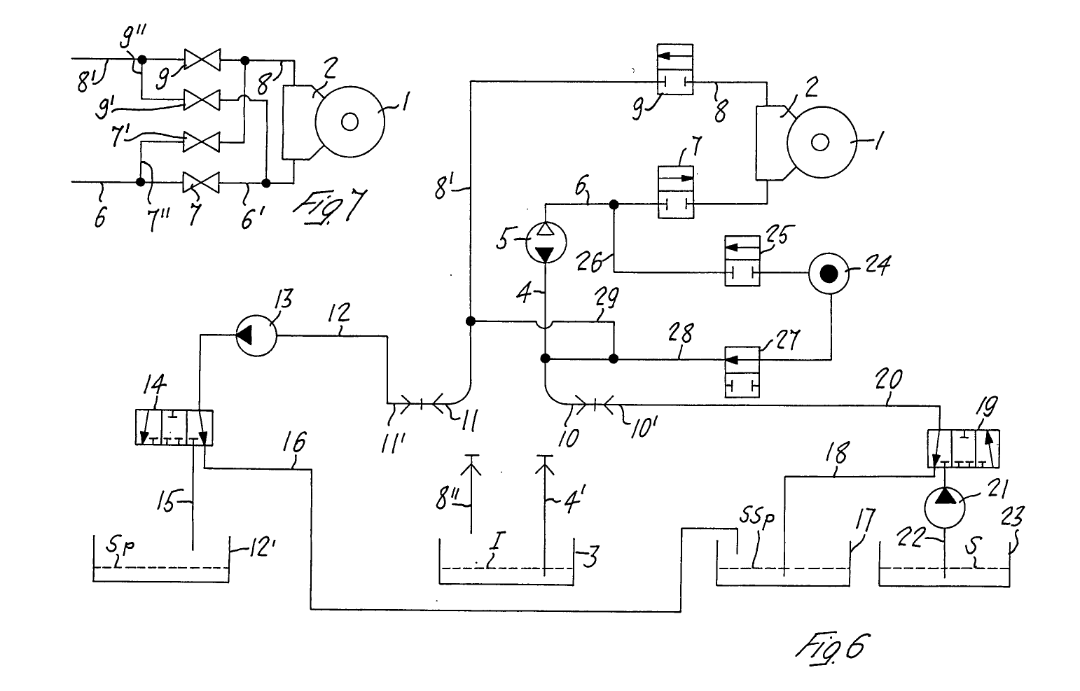

FIG. 6 illustrates the final step of emptying from the inking lines the solvent still contained therein using a high-pressure air flow which precedes the new inking step with supplying of new ink to the press; and

FIG. 7 shows a detail of a variation of embodiment of the circuit for washing the inking chamber housing the doctor blades.

With reference to the drawings and with particular reference to FIG. 1 thereof, 1 denotes the inking cylinder and for example the screened cylinder (anilox cylinder) of a flexographic printing press. 2 denotes the chamber for supplying the ink to the cylinder 1, which also contains a scraper or doctor blade (not shown) having the purpose of ensuring a uniform layer of the ink film on the surface of the cylinder 1. 3 denotes the ink collection tray into which the line 4′, connected by means of the quick-action coupling 10 and the line 4 to the pump 5, leads. According to a characteristic feature of the present invention, the pump 5 is of the type having a reversible delivery and intake, and in particular said pump is a peristaltic pump. The pump 5 is connected in turn by means of the line 6 and the pneumatically controlled diaphragm valve 7 to the chamber 2. The chamber 2 is in turn connected by means of the line 8, the diaphragm valve 9, the line 8′, the quick-action coupling 11 and the line 8″ to the tank 3. Therefore, during the course of a normal printing operation, the ink I contained in the tank 3 is circulated by the pump 5, being sucked via the line 4′, the coupling 10, the line 4, the line 6 and the valve 7 into the chamber 2, where it is spread onto the inking cylinder 3, and is made to flow from the chamber 2 via the line 8, the valve 9, the line 8′, the quick-action coupling 11 and the line 8″ back into the tank 3 from where the ink is again supplied to the cylinder 3, thus closing a continuous cycle for supplying ink to the inking cylinder 1.

The plant is completed by a line 12 provided at one end with a quick-action coupling element 11′ and connected to the double-diaphragm pneumatic pump 13 connected to the twin valve 14 which in a first position discharges, by means of the line 15, into the tank 12′ for the dirty solvent Sp and in a second position discharges, by means of the line 16, into the tank 17 for the semi-dirty solvent SSp. The tank 17 is in turn connected, by means of a line 18 comprising a twin valve 19 which, in one of its switched positions, connects the line 18 to the line 20 terminating in the quick-action coupling element 10′, while, in the other switched position of the valve 19, the line 20 is connected to the delivery of the pump 21, the intake side of which is connected to the line 22 which leads into the tank 23 containing the clean solvent S. The automatic washing circuit described is completed by a compressed-air source 24 comprising a branch supplying air at a low pressure, for example at a pressure of about 0.5 bar, connected by means of the shut-off valve 25 and the line 26 to the line 6 at a point between the pump 5 and the valve 7 and a branch supplying air at medium pressure, for example at a pressure of about 2 bar connected, by means of the shut-off valve 27 and the line 28 to the line 4 at a point thereof between the pump 5 and the quick-action coupling 10 and connected by means of the branch 29 to the line 8 at a point thereof between the quick-action coupling 11 and the shut-off valve 9, for the purposes which will be described below.

With reference to FIG. 2, the first step of the method for washing the inking circuit described above will now be described. During this step, the direction of pumping of the pump 5 is reversed, thus sucking all the ink present inside the doctor-blade chamber 2 and in the line 6 and conveying it via the line 4 into the tank 3. At the same time, the branch of the line 8 is also emptied by means of gravity into the tank 3 so that the circuit formed by the lines 4, pump 5, line 6, chamber 2 and line 8 are at the end of this operation emptied of the ink therein which is conveyed back into the tank 3 for the ink I. At this point one passes to the next step of the automatic washing step. This step, which is shown in FIG. 3, comprises preliminarily disconnection of the quick-action coupling elements 10 and 11 from the pipe sections 4′ and 8″, respectively, and their connection to the quick-action coupling elements 10′ and 11′, respectively. This operation of disconnection and subsequent connection of the quick-action couplings is preferably performed manually. However, this operation could also be automated by means of suitable robotized devices. Moreover, the valve element 19 is switched so as to establish a connection between the line 18 and the line 20; the valve element 14 is switched so as to establish a connection between the delivery of the pump 13 and the line 15 which discharges into the tank 12′ and the valve element 25 is intermittently switched so as to establish communication between the source of low-pressure air supplied from 24 and the line 26. During this step, the action of the pump 5 is again reversed, so that operation of the pump 5 causes suction of the semi-dirty solvent SSp from the tank 17, via the line 18, the valve 19, the line 20, the coupling 10′, 10, the line 4, the pump 5, the line 6 and the valve 7 into the chamber 2. As it passes along the line 6, air at low pressure is injected at intervals from the line 26 into the line 6. This injection results in the formation, along the lines in question—and in particular the lines 6, 8 and 8′—as well as inside the chamber 2, of a series of air bubbles A which are arranged at more or less regular distances within the flow F of solvent as shown schematically in FIG. 3A. The presence of these air bubbles, namely of a fluid which can be compressed within the body of liquid, and the pulses due to the intermittent introduction of the air into the flow of solvent, produces a continuous intermittent acceleration of the body of solvent supplied through the chamber 2 and the lines 8 and 8′, and this intermittent accelerating movement of the body of solvent results, with its mechanical action, in an increase in the removal of the ink performed by the solvent from the walls of the pipes in question and the components of the chamber 2. The solvent charged with ink resulting from this first operation is discharged from the line 8′ via the couplings 11,11′, the line 12, the pump 13, the valve 14 and the line 15 into the tank 12′ for the dirty solvent Sp. During this washing step, the inking cylinder 1 is run at a low speed.

During the following step, illustrated in FIG. 4, the valve 14 is switched so as to connect the delivery of the pump 13 to the line 16. All the other connections remain, during this step, unchanged. At this point, the semi-dirty solvent from the tank 17 is circulated as described with reference to the step in FIG. 3, with the sole difference that, instead of being discharged into the tank 12′, it is recycled along the line 16 back into the tank 17. During this step also, the pulsed injection of air into the flow of solvent continues via the line 26. Below, in a manner entirely similar to that described with reference to the first step of the cycle, emptying of the semi-dirty solvent from the lines is performed by means of reversal of the peristaltic pump 5. The semi-dirty solvent is therefore conveyed back into the tank 17. At the end of this new operating cycle, the valve 19 (see diagram in FIG. 5) is switched so as to interrupt the connection between the tank 17 and the line 20, and the latter is connected to the delivery of the pump 21 associated with the tank 23 for the clean solvent. During this step also, the pulsed injection of air into the flow of clean solvent is continued via the line 26, and the solvent circulated in this way, as described with reference to the step illustrated in FIG. 4, is collected inside the tank 17 for the semi-dirty solvent.

At this point the final step of the automatic washing operation commences. During this step the direction of the pump 5 is reversed firstly so as to empty the pipes and the chamber 2 of the clean solvent, which is collected inside the tank 17. At the same time the flow of low-pressure air from the line 26 is interrupted by means of switching of the valve 25, and the valve 19 is reset to the switched position shown in FIG. 4. Then the valves 7 and 9 in turn are switched into the closed position so as to prevent the air at a pressure of 2 bar from pressurising the chamber 2. Finally, the valve 27 is switched so as to convey a flow of air at a high pressure along the pipes, so as to discharge completely the solvent contained in them, performing also drying of the residual solvent in the said pipes. After this, it is possible to perform disconnection of the quick-action couplings 10 and 11 from the couplings 10′ and 11′ and reconnection thereof to the pipes 8″ and 4′, re-establishing at the same time the operating conditions described with reference to FIG. 1.

Obviously the washing method according to the present invention is not limited to the operating steps described and illustrated. Thus, for example, it is possible to envisage using simplified and shortened procedures in the case where the press must be stopped for a relatively short period of time, without it being necessary to change the ink, in which case it is possible, for example, to omit the initial washing steps using semi-dirty solvent.

FIG. 7 illustrates a variant of the cycle for washing the inking chamber 2 of the printing cylinder 1. According to this variant, the lines 6′ and 8′ are connected together by means of a line 9″, with insertion of a valve 9′ and, likewise, the lines 6 and 8 have been connected together by means of a line 7″ with the insertion of a valve 7′. Owing to this particular circuit arrangement it is possible to pump solvent which is both clean and semi-dirty from those holes which under normal conditions are the discharge holes of the chamber 2 and discharge solvent from the hole which under normal conditions is the hole supplying the doctor blade. In fact, by closing the valves 7 and 9 and opening the valves 7′ and 8′, the result is obtained whereby the pipe section 8 is completely washed, first with semi-dirty solvent and then with clean solvent.

Although reference has always been made during the course of the description to the pump 5 as being a peristaltic pump, it is understood that, instead of this pump, it would be possible to use two double-diaphragm pneumatic pumps, with two supply lines.

Obviously, in a polychromatic printing press, there will be as many modules such as those described above as there are different printing stations.

The washing system according to the invention may be completely automated and its electronics may be incorporated into the electronics of the printing press. It may be controlled by means of software which allows the washing cycles to be programmed according to the specific requirements of the individual users.

Obviously, the present invention is not limited to that described and illustrated, but comprises all those variants and modifications which fall within the more general scope of the inventive idea, substantially as claimed below.

1. Plant for automatically washing the inking circuit in rotary printing presses, comprising: a chamber for inking the inking cylinder; lines which connect said chamber to a tank for the ink; means for pumping the ink from said tank along said lines to said chamber and from the latter back into the tank; a tank for the clean solvent; lines provided with means able to connect said tank to said line; a tank for the dirty solvent and lines provided with means able to connect said tank to said line, characterized in that said means for pumping the ink consist of a peristaltic pump, the rotor of which is actuated by a motor with a reversible direction of rotation.

2. Plant according to claim 1, in which said means able to connect said tank to said line and said tank to said line consist of quick-action couplings.

3. Plant according to claim 1, further comprising a tank for the semi-dirty solvent, switching valve means able to connect said tank to the lines and, respectively, via the lines and being provided.

4. Plant according to claim 1, further comprising a source of compressed low-pressure air connected, by means of shut-off means to a line which is branched to the line upstream of the inking chambers.

5. Plant according to claim 1, further comprising a source of compressed high-pressure air connected, by means of shut-off means, to a first line which is branched to the line upstream of the pump and to a second line which is branched to the line 8′ downstream of the inking chamber.

6. Plant according to claim 1, in which a pump is inserted into the circuit between said line and said switching valve means.

7. Plant according to claim 1, in which a pump is inserted into the circuit between said line and said switching valve means.

8. Plant according claim 6, in which said pumps are pneumatic pumps of the double diaphragm type.

9. Plant according to claim 3, in which said source of low-pressure air is a source of air at a pressure of between 0.3 and 0.7 bar and preferably at a pressure of 0.5 bar.

10. Plant according to claim 4, in which said source of high-pressure air is a source of air at a pressure of between 1.5 and 3 bar and preferably at a pressure of 2 bar.

11. Plant according to claim 3, in which means are provided for supplying said low-pressure air in the line by means of closely spaced intermittent pulses.

12. Plant according to the claim 1 in which, adjacent to the chamber, the lines and are connected together by means of a line, with the insertion of a valve, and likewise the lines and are connected together by means of a line with the insertion of a valve so as to allow both clean and semi-dirty solvent to be pumped from what is under normal conditions the discharge hole of the chamber and allow solvent to be discharged from the hole which under normal conditions is the hole supplying the said chambers, so that, by means of closing of the valves and opening of the valves and, it is possible to wash thoroughly, first with semi-dirty solvent and then with clean solvent, the pipe section.

13. Method for automatically washing the circuit in rotary printing presses using the plant in accordance with claim 1, comprising the steps of:
inverting the direction of rotation of the rotor of the pump so as to empty the ink contained in the chamber and in the lines, conveying it back into the tank and at the same time causing the ink contained in the lines to flow back by means of gravity into the same tank.
disconnecting the quick-action coupling elements from the lines and connecting them to the quick-action coupling elements;
switching the valve element so as to establish communication between the line supplying the semi-dirty solvent from the tank and the line communicating via the couplings with the line 4;
switching the valve element so as to connect the line, the couplings, the line and the pump to the line leading into the tank for collecting the dirty solvent;
renewed reversal of the direction of rotation of the rotor of the pump so as to pump the solvent from the tank for the semi-dirty solvent via the line, the chamber, the lines into the tank, with simultaneous opening of the valve so as to inject intermittently compressed low-pressure air into the line, within the flow of semi-dirty solvent;
switching the valve so as to connect the delivery of the pump to the line leading into the tank and continued circulation, in a closed cycle, of the semi-dirty solvent through the circuit of the chamber, continuing the intermittent introduction of low-pressure air into the solvent which is circulated;
emptying from the lines the semi-dirty solvent by means of reversal of the peristaltic pump, with conveying of the semi-dirty solvent back into the tank;
switching the valve so as to connect the tank for the clean solvent to the flow circuit of the chamber, with discharging of the semi-dirty solvent obtained at the end of the cycle into the tank for the semi-dirty solvent, continuing the intermittent introduction of low-pressure air into the clean solvent which is circulated;
switching the valve so as to connect the line to the tank for the semi-dirty solvent, interrupting the supply of low-pressure air; reversing the direction of rotation of the rotor of the pump so as to cause all the solvent contained in the lines to flow back into the tank for the semi-dirty solvent; switching the valves and into the intercepting position; switching the valve so as to supply high-pressure air into the solvent conveying lines; and subsequent blowing of the high-pressure air through the valve so as to perform emptying and partial drying of said lines using the high-pressure air;
reconnection to the tank containing the ink.

14. Method according to claim 13, in which during the first washing step using semi-dirty solvent, the inking cylinder is made to run at low speed, while during the subsequent washing steps using semi-dirty solvent and clean solvent the inking cylinder is made to run at high speed, alternating the rotation in either direction so as to create a turbulence which removes the residual ink from the chamber and from the cells of the cylinder.

15. Method for automatically washing the inking circuit in rotary printing presses according to claim 14, characterized by the step of intermittently introducing air into the flow of solvent circulated in the lines to be washed, causing an intermittent acceleration of the body of solvent inside the lines, which increases the action of separation of the ink from the walls of the lines by the solvent.

16. Plant according to claim 7, in which said pumps are pneumatic pumps of the double diaphragm type.

17. Method for automatically washing the inking circuit in rotary printing presses according to claim 14, characterized by the step of intermittently introducing air into the flow of solvent circulated in the lines to be washed, causing an intermittent acceleration of the body of solvent inside the lines, which increases the action of separation of the ink from the walls of the lines by the solvent.
